(19) United States
(12) Patent Application Publication
(10) Pub. No.: US 2013/0120686 A1
(43) Pub. Date: May 16, 2013

(54) DISPLAY DEVICE

(71) Applicant: JAPAN DISPLAY WEST, INC., Aichi-Ken (JP)

(72) Inventors: Hiroki Kato, Tottori (JP); Goki Aoki, Tottori (JP); Hiroyuki Nakamura, Tottori (JP)

(73) Assignee: JAPAN DISPLAY WEST, INC., Aichi-Ken (JP)

(21) Appl. No.: 13/668,972

(22) Filed: Nov. 5, 2012

(30) Foreign Application Priority Data
Nov. 11, 2011 (JP) 2011-247763

(51) Int. Cl. G02F 1/13357

(52) U.S. Cl. 349/61

(57) ABSTRACT

A display device includes a display panel module, a backlight configured to illuminate the display panel module from behind, and a securing layer provided between the display panel module and the backlight to secure the display panel module to the backlight at their corresponding outer edges. The display panel module includes a light modulation panel including a pixel region having a plurality of pixels arranged therein, a pair of polarizing plates facing each other with the light modulation panel in between, and a reinforcing member provided between the one of the pair of polarizing plates disposed toward the backlight and the light modulation panel or the securing layer.

### BACKGROUND

The present technology relates to a display device equipped with a liquid crystal panel.

In recent years, liquid crystal panels have come into use in various places in automobiles. For example, a liquid crystal panel is used in a display unit of a car navigation device. Recently, liquid crystal panels are increasingly being used on an instrument panel for displaying vehicle speed, engine revolutions, fuel level, engine cooling water temperature, etc.

In an in-vehicle electronic device, bonding members are typically used to secure components to each other to prevent the components from wobbling and/or being damaged due to vibrations caused by the movement of the automobile. For example, in an in-vehicle display, a double-sided tape is provided between a liquid crystal panel and a backlight to secure them to each other (see Japanese Unexamined Patent Application Publication No. 2011-186024). Apart from securing the liquid crystal panel and the backlight to each other, this double-sided tape also serves to prevent dust from entering between them.

### SUMMARY

In the in-vehicle display described above, the portion in the upper surface of the backlight to which the liquid crystal panel is secured (referred to hereinafter as the installation surface) may not be completely horizontal, with a slight tilt and/or undulation. This may be caused by manufacturing error arising during the manufacture of the backlight housing or thermal history during use, for example. Non-uniform flatness of the installation surface applies stress to the liquid crystal panel secured to the backlight with a double-sided tape, thereby causing brightness irregularities.

It is desirable to provide a display device capable of reduce the brightness irregularities caused by the stress.

A display device according to an embodiment of the present technology includes a display panel module, a backlight adapted to illuminate the display panel module from behind, and a securing layer provided between the display panel module and the backlight to secure the display panel module and the backlight to each other at their corresponding outer edges. The display panel module includes a light modulation panel having a pixel region including a plurality of pixels arranged therein, a pair of polarizing plates facing each other with the light modulation panel in between, and a reinforcing member provided between the one of the pair of polarizing plates disposed toward the backlight and the light modulation panel or the securing layer.

In the display device according to this embodiment of the present technology, the reinforcing member is provided between the polarizing plate disposed toward the backlight and the light modulation panel or the securing layer. This configuration can reduce the stress applied to the light modulation panel by a curvature of the light modulation panel due to non-uniform flatness of the upper surface (installation surface) of the backlight.

The display device according to this embodiment of the present technology can reduce stress applied to the light modulation panel and thereby reduce brightness irregularities due to the stress.

### BRIEF DESCRIPTION OF THE DRAWINGS

FIG. 1 is a sectional view showing the structure of a display device according to an embodiment of the present technology;

FIG. 2 is a developed perspective view of the display device in FIG. 1;

FIG. 3 is a sectional view showing the structure of a variation of the display device in FIG. 1;

FIG. 4 is a perspective view of an electronic device in an application of the display device in FIG. 1 or 3; and

FIG. 5 is a front view of an instrument panel in another application of the display device in FIG. 1 or 3.

### DETAILED DESCRIPTION OF EMBODIMENTS

An embodiment of the present technology will now be described in detail with reference to the drawings. The description will be given in the following order:

1. Embodiment

2. Variation

3. Applications

### 1. Embodiment

### [Structure]

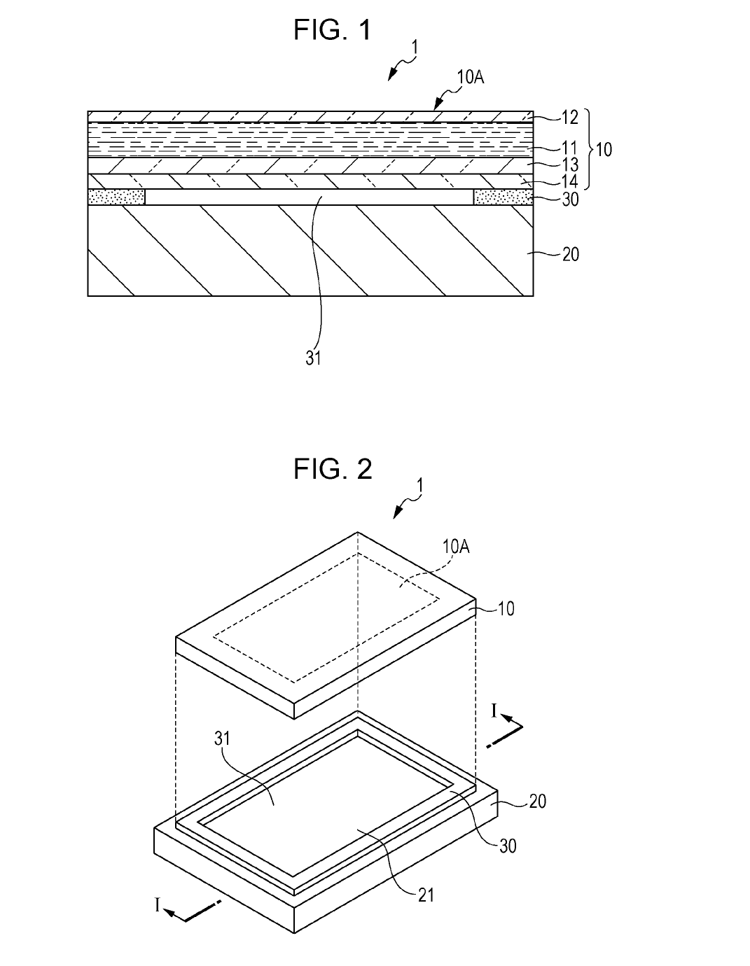

First, a display device 1 according to an embodiment of the present technology will be described. FIG. 1 is a sectional view schematically showing an exemplary structure of the display device 1. FIG. 2 is a developed perspective view schematically showing the exemplary structure of the display device 1. FIG. 1 corresponds to a cross section taken along line I-I in FIG. 2. The display device 1 includes a display panel module 10, a backlight 20 mounted behind the display panel module 10, and a securing layer 30 provided between the display panel module 10 and the backlight 20.

The display device 1 also includes, although not shown, a driver board and a flexible printed circuit (FPC) board. The driver board is disposed behind the backlight 20, for example, and causes the display panel module 10 to display video by driving the display panel module 10. The FPC board electrically connects the display panel module 10 to the driver board.

### (Display Panel Module 10)

The display panel module 10, which displays video, is rectangular in shape, for example, with four sides as shown in FIG. 2. The display panel module 10 displays video by modulating incident light, for example; more specifically, it is a transmissive display panel that, when the pixels are driven in accordance with a video signal, modulates incident light entered from behind and outputs image light through the upper surface, for example. The display panel module 10 includes a liquid crystal panel 11 having a pair of glass substrates with a liquid crystal layer in between and a pair of polarizing plates 12, 13 facing each other with the liquid crystal panel 11 in between.

The liquid crystal panel 11 has a pixel region including a plurality of pixels arranged therein. The region in the upper surface of the display panel module 10 corresponding to the pixel region forms a video display surface 10A. The region in the upper surface of the display panel module 10 corresponding to the outer edges (more specifically, the periphery around the video display surface 10A) forms a frame region not displaying video. The liquid crystal panel 11 includes, although not shown, a first glass substrate, pixel electrodes, first alignment film, liquid crystal layer, second alignment film, common electrode, color filter, and second glass substrate in this order, the first glass substrate being the closest to the backlight 20, for example.

The polarizing plates 12, 13 are a kind of optical shutter and allow only the light with a certain direction of vibration (polarized light) to pass therethrough. The polarizing plates 12, 13 are arranged such that their polarization axes are shifted by 90 degrees from each other, so that the light emitted from the backlight 20 passes through or is blocked by the liquid crystal layer. Of the pair of polarizing plates 12, 13, the polarizing plate 12 disposed away from the backlight 20 (i.e., the one disposed toward the video display surface 10A) has an antireflective film or other optical film as necessary on the surface thereof.

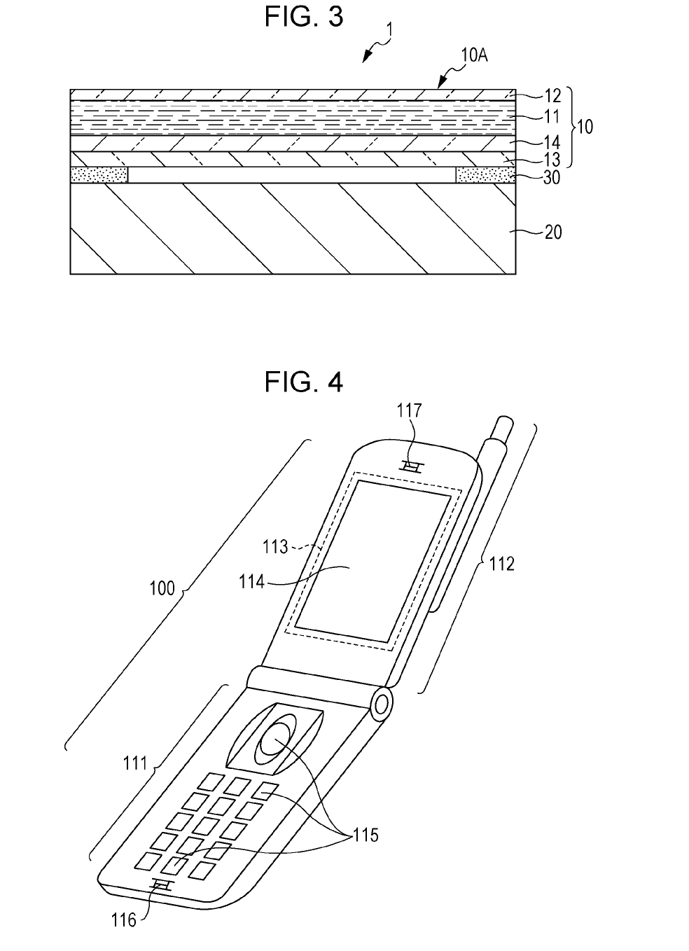

The display panel module 10 further includes a reinforcing member 14 between the polarizing plate 13, which is the one of the pair of polarizing plates 12, 13 disposed toward the backlight 20, and the securing layer 30. The reinforcing member 14 reduces the curvature of the liquid crystal panel 11 due to non-uniform flatness of the upper surface (installation surface) of the backlight 20 when the display panel module 10 is bonded to the backlight 20 with the securing layer 30 in between. The reinforcing member 14 is made of a material providing, despite its thinness, a high rigidity and excellent flatness, compared with the material used for the polarizing plates 12, 13. The reinforcing member 14 is made of, for example, a glass substrate. Preferably, this glass substrate has a thickness equal to or larger than the glass substrate used for the liquid crystal panel 11. Depending on specifications, however, there may be no problem even if the glass substrate used for the reinforcing member 14 is thinner than the glass substrate used for the liquid crystal panel 11. Preferably, the reinforcing member 14 is disposed within the region facing the liquid crystal panel 11, in a sub-region facing at least the video display surface 10A (pixel region) to be described later. In a positional relationship with the liquid crystal panel 11 in the display panel module 10, the reinforcing member 14 is desirably disposed toward the backlight 20. The reinforcing member 14 may be disposed between the polarizing plate 13 and the liquid crystal panel 11, for example, as shown in FIG. 3.

### (Backlight 20)

The backlight 20 illuminates the display panel module 10 from behind. The backlight 20 is an edge type lighting system, for example, including a light guide plate, light sources disposed at ends of the light guide plate, various optical films disposed on the upper surface of the light guide plate, for example. Alternatively, the backlight 20 may be a direct type lighting system including various optical films disposed directly above the light sources. The backlight 20 has a housing covering the above-mentioned light sources, etc. This housing includes a container body (base) on which the above-mentioned light sources, etc. are placed and a cover (frame) that is combined with the base to protect the above-mentioned light sources, etc. from external impact or the like. The frame has an opening 21 corresponding to the video display surface 10A of the display panel module 10. The video display surface 10A and the opening 21 are positioned with respect to each other by securing the base and the frame to each other with bolts or the like.

### (Securing Layer 30)

The securing layer 30 secures the display panel module 10 and the backlight 20 to each other. The securing layer 30 is formed from a bonding layer or an adhesive layer. The securing layer 30 is made of, for example, a spongiform double-sided tape and secures or bonds the display panel module 10 and the backlight 20 to each other at their corresponding outer edges. The securing layer 30 is disposed in correspondence with the frame region of the display panel module 10. When the display panel module 10 is rectangular in shape with four sides as shown in FIG. 2, the securing layer 30 is also rectangular in shape with four sides, for example, defining an opening 31 corresponding to the video display surface 10A. Alternatively, separate pieces of the securing layer 30 may be provided in correspondence with the sides of the frame region of the display panel module 10. When separate pieces of the securing layer 30 are provided in correspondence with the sides of the frame region of the display panel module 10, each piece of the securing layer 30 has a strip-like shape, for example. Such pieces of the securing layer 30 may be provided on some sides of the frame region of the display panel module 10. The securing layer 30 is formed from a bonding layer or an adhesive layer, for example.

### [Effects]

Effects of the display device 1 will now be described. In the display device 1, the reinforcing member 14 is provided between the polarizing plate 13 disposed toward the backlight 20 and the liquid crystal panel 11 or securing layer 30. This configuration can reduce the stress applied to the liquid crystal panel 11 due to a curvature of the liquid crystal panel 11 caused by non-uniform flatness of the upper surface (installation surface) of the backlight 20, and thereby reduce the brightness irregularities due to the stress.

Since the reinforcing member 14 is disposed toward the backlight 20 in a positional relationship with the liquid crystal panel 11, the display device 1 can reduce possible adverse effects on the display quality, compared with the case in which the reinforcing member 14 is disposed toward the video display surface 10A in the positional relationship with the liquid crystal panel 11. In the display device 1, the reinforcing member 14 is a new optical member and the material, thickness, or other properties of the existing optical members are not modified. This means that brightness irregularities due to the stress can be reduced only by adding the reinforcing member 14, without design changes in the existing optical members.

### 2. Variation

Although the display panel module 10 in the above embodiment includes the liquid crystal panel 11, the display panel module 10 may include a light modulation panel that modulates light in a manner different from the liquid crystal panel 11.

### 3. Applications

### [First Application]

In the following, an application of the display device 1 according to the above embodiment and the variation thereof will be described. FIG. 4 is a perspective view schematically showing the structure of an electronic device 100 in this application. The electronic device 100 is a mobile telephone including a main body 111 and a display body 112 attached to the main body 111 so as to be opened or closed with respect to the main body 111, for example, as shown in FIG. 4. The main body 111 has operation buttons 115 and a microphone 116. The display body 112 has a display device 113 and a speaker 117. The display device 113 has a display screen 114 on which various telephone communication-related indications are displayed. The electronic device 100 has a control unit (not shown) for controlling operations of the display device 113. This control unit is disposed within the main body 111 or display body 112, as an integral or separate part of a controller that controls the electronic device 100 as a whole.

The display device 113 has the same structure as the display device 1 according to the above embodiment and the variation thereof. This allows the video display surface of the display panel module 10 to be arranged accurately in the desired place on the display screen 114 of the display device 113.

### [Second Application]

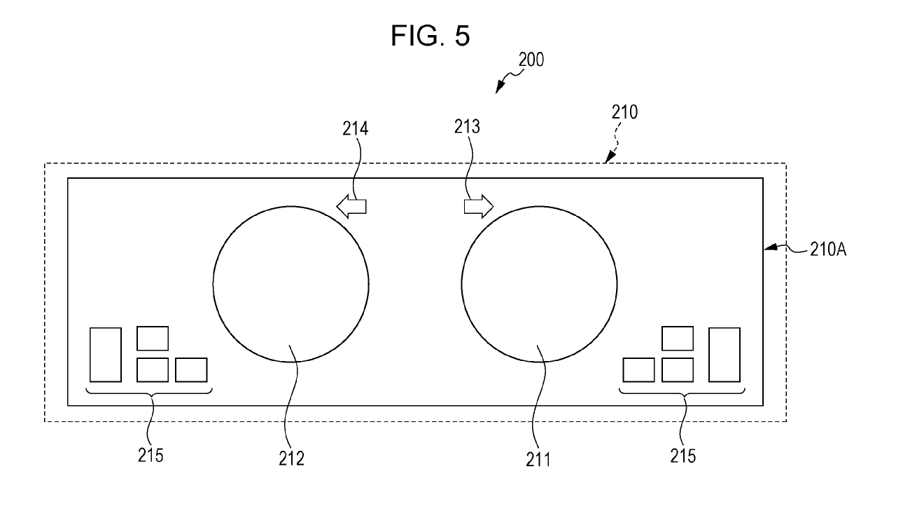

Next, another application of the display device 1 according to the above embodiment and the variation thereof will be described. FIG. 5 is a front view schematically showing the structure of an instrument panel 200 in this application. The instrument panel 200 includes a display device 210 and is disposed in front of the driver's seat in the automobile. The display device 210 has a display screen 210A on which various information necessary to drive the automobile is displayed. The display device 210 displays, for example, vehicle speed 211, engine revolutions 212, right turn 213, left turn 214, and various information 215 such as fuel level and engine cooling water temperature, as shown in FIG. 5.

The display device 210 has the same structure as the display device 1 according to the above embodiment and the variation thereof. This makes it possible to reduce brightness irregularities in the display device 210.

Electronic devices in which the display device 1 according to the above embodiment and the variation thereof can be applied include, in addition to the mobile telephone described above, personal computers, liquid crystal televisions, viewfinder type or direct-view monitor type video tape recorders, car navigators, pagers, electronic organizers, electronic calculators, word processors, workstations, videophones, and POS terminals.

The embodiment of the present technology can adopt the following structures, for example:

(1) A display device including: a display panel module; a backlight configured to illuminate the display panel module from behind; and a securing layer provided between the display panel module and the backlight to secure the display panel module to the backlight at their corresponding outer edges; wherein the display panel module includes a light modulation panel including a pixel region having a plurality of pixels arranged therein, a pair of polarizing plates facing each other with the light modulation panel in between, and a reinforcing member provided between the one of the pair of polarizing plates disposed toward the backlight and the light modulation panel or the securing layer.

(2) The display device according to item (1), wherein the reinforcing member is a glass substrate.

(3) The display device according to item (1) or (2), wherein the reinforcing member is disposed within a region facing the light modulation panel, in a sub-region facing at least the pixel region.

(4) The display device according to any one of items (1) to (3), wherein the light modulation panel is a liquid crystal panel.

The present disclosure contains subject matter related to that disclosed in Japanese Priority Patent Application JP 2011-247763 filed in the Japan Patent Office on Nov. 11, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display panel module;
a backlight configured to illuminate the display panel module from behind; and
a securing layer provided between the display panel module and the backlight to secure the display panel module to the backlight at corresponding outer edges thereof;
wherein the display panel module includes
a light modulation panel including a pixel region having a plurality of pixels arranged therein,
a pair of polarizing plates facing each other with the light modulation panel in between, and
a reinforcing member provided between one of the pair of polarizing plates disposed toward the backlight and the light modulation panel or the securing layer.

2. The display device according to claim 1,
wherein the reinforcing member is a glass substrate.

3. The display device according to claim 1,
wherein the reinforcing member is disposed within a region facing the light modulation panel, in a sub-region facing at least the pixel region.

4. The display device according to claim 1,
wherein the light modulation panel is a liquid crystal panel.
